(19) United States
(12) Patent Application Publication
(10) Pub. No.: US 2019/0176721 A1
(43) Pub. Date: Jun. 13, 2019

(54) VEHICLE WIRE HARNESS WITH VISUAL INDICATOR FOR EASE OF ASSEMBLY

(71) Applicant: GM Global Technology Operations LLC, Detroit, MI (US)

(72) Inventors: Yue FAN, Troy, MI (US); Pinakin NAIK, Sterling Heights, MI (US); Charanjit S. CHAWA, Sterling Heights, MI (US)

(21) Appl. No.: 15/837,641

(22) Filed: Dec. 11, 2017

(51) Int. Cl. B60R 16/02; H01B 7/36; B60R 16/033; H01R 13/64

(52) U.S. Cl. CPC B60R 16/0207; H01R 13/64; B60R 16/033; H01B 7/365

(57) ABSTRACT

A wire harness of a vehicle includes a trunk including a plurality of wires that are bundled together. A first branch branches from the trunk at a location and includes a first subset of the plurality of wires. A first electrical connector is electrically connected to the wires of the first subset of the plurality of wires, respectively. A second branch branches from the trunk at the location and that includes a second subset of the plurality of wires. The wires of the second subset of the plurality of wires are different than the wires of the first subset of the plurality of wires. A second electrical connector is electrically connected to the wires of the second subset of the plurality of wires, respectively. A visual indicator is located directly on a predetermined one of the first and second branches.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicles and more particularly to wire harnesses of vehicles.

A vehicle may include an engine that combusts air/fuel mixture to generate drive torque. An engine control module (ECM) controls the engine. The vehicle may also include one or more electric motors. An electric motor can act as either a generator or as a motor at a given time. When acting as a generator, an electric motor converts mechanical energy into electrical energy. The electrical energy may be, for example, used to charge a battery via a power control device (PCD).

The vehicle includes one or more wire harnesses. Wire harnesses can also be referred to as wiring harnesses. A wire harness includes a plurality of individual wires. Each wire includes at least one electrical conductor and at least one electrical insulator (e.g., surrounding an electrical conductor). As an example, wires of a wire harness connect components of the engine (e.g., actuators and sensors) to the ECM. Other wires of the wire harness or wires of another wire harness connect the electric motor and other associated components (e.g., actuators and sensors) to the PCD.

### SUMMARY

In a feature, a wire harness of a vehicle includes a trunk including a plurality of wires that are bundled together. A first branch branches from the trunk at a location and includes a first subset of the plurality of wires. A first electrical connector that is electrically connected to the wires of the first subset of the plurality of wires, respectively. A second branch branches from the trunk at the location and includes a second subset of the plurality of wires. The wires of the second subset of the plurality of wires are different than the wires of the first subset of the plurality of wires. A second electrical connector is electrically connected to the wires of the second subset of the plurality of wires, respectively. A third branch branches from the trunk at the location and includes a third subset of the plurality of wires. The wires of the third subset of the plurality of wires are different than the wires of the first subset of the plurality of wires, and the wires of the second subset of the plurality of wires. A third electrical connector is electrically connected to the wires of the third subset of the plurality of wires, respectively. A visual indicator is located directly on a predetermined one of the first, second, and third branches.

In further features: the first branch has a first length; the second branch has a second length that is greater than the first length; the third branch has a third length that is greater than the second length; and the visual indicator is located directly on the second branch.

In further features: a first difference between the first length and the second length is less than a predetermined length; and a second difference between the second length and the third length is less than the predetermined length.

In further features: one of the plurality of wires includes an electrical insulator that is the same color as electrical insulators of all of the other ones of the plurality of wires; a first difference between a first length of the first branch and a second length of the second branch is less than a predetermined length; a second difference between the second length of the second branch and a third length of the third branch is less than the predetermined length; and the first electrical connector is the same color as the second and third electrical connectors.

In further features, the visual indicator includes one of the first, second, and third electrical connectors connected to the predetermined one of the first, second, and third branches being a different color than the other ones of the first, second, and third electrical connectors.

In further features, the visual indicator includes one of the first, second, and third subsets of the plurality of wires being a different color than the other ones of the first, second, and third subsets of the plurality of wires.

In further features, the visual indicator is a label that is directly on the predetermined one of the first, second, and third branches.

In further features, the label is printed directly on the predetermined one of the first, second, and third branches.

In further features, the label is affixed directly to the predetermined one of the first, second, and third branches.

In further features, the label includes a part number of the wire harness.

In further features, the label includes a unique identifier of the wire harness.

In further features, the label includes a visual indicator of which one of a plurality of mating connectors that is to be mated with the one of the first, second, and third electrical connectors that is connected to the predetermined one the first, second, and third branches.

In further features, the label includes a visual indicator of whether the first, second, and third branches should be installed more toward one of: a front of the vehicle; and a rear of the vehicle.

In further features, the label includes a visual indicator of whether the first, second, and third branches should be installed more toward one of: a left side of the vehicle; and a right side of the vehicle.

In further features, the label includes a visual indicator of whether the first, second, and third branches should be installed more toward one of: a top of the vehicle; and a bottom of the vehicle.

In further features, the label: is affixed directly to the predetermined one of the first, second, and third branches; includes a part number of the wire harness; includes a unique identifier of the wire harness; includes a first visual indicator of which one of a plurality of mating connectors that is to be mated with the one of the first, second, and third electrical connectors that is connected to the predetermined one the first, second, and third branches; includes a second visual indicator of whether the first, second, and third branches should be installed more toward one of: a front of the vehicle; and a rear of the vehicle; includes a third visual indicator of whether the first, second, and third branches should be installed more toward one of: a left side of the vehicle; and a right side of the vehicle; and includes a fourth visual indicator of whether the first, second, and third branches should be installed more toward one of: a top of the vehicle; and a bottom of the vehicle.

In further features, a vehicle includes: a battery; a plurality of switching devices that are electrically connected to the battery; an electric heater; a battery charger configured to charge the battery; and a compressor including an electric motor; where the wire harness is connected: to the plurality of switching devices at a first end of the wire harness; to the electric heater via the first electrical connector; to the battery charger via the second electrical connector; and to the compressor via the third electrical connector.

In a feature, a wire harness of a vehicle includes a trunk including a plurality of wires that are bundled together. A first branch branches from the trunk at a location and includes a first subset of the plurality of wires. A first electrical connector is electrically connected to the wires of the first subset of the plurality of wires, respectively. A second branch branches from the trunk at the location and includes a second subset of the plurality of wires. The wires of the second subset of the plurality of wires are different than the wires of the first subset of the plurality of wires. A second electrical connector is electrically connected to the wires of the second subset of the plurality of wires, respectively. A third branch branches from the trunk at the location and includes a third subset of the plurality of wires. The wires of the third subset of the plurality of wires are different than the wires of the first subset of the plurality of wires, and the wires of the second subset of the plurality of wires. A third electrical connector is electrically connected to the wires of the third subset of the plurality of wires, respectively. A label is affixed directly to a predetermined one of the first, second, and third branches and not on the trunk. The label includes: a part number of the wire harness; a unique identifier of the wire harness; a first visual indicator of which one of a plurality of mating connectors that is to be mated with the one of the first, second, and third electrical connectors that is connected to the predetermined one the first, second, and third branches; a second visual indicator of whether the first, second, and third branches should be installed more toward: a front of the vehicle; or a rear of the vehicle; a third visual indicator of whether the first, second, and third branches should be installed more toward: a left side of the vehicle; or a right side of the vehicle; a fourth visual indicator of whether the first, second, and third branches should be installed more toward: a top of the vehicle; or a bottom of the vehicle. One of the plurality of wires includes an electrical insulator that is the same color as electrical insulators of all of the other ones of the plurality of wires, a first difference between a first length of the first branch and a second length of the second branch is less than a predetermined length, a second difference between the second length of the second branch and a third length of the third branch is less than the predetermined length, and the first electrical connector is the same color as the second and third electrical connectors.

In further features, a vehicle includes a battery; a plurality of switching devices that are electrically connected to the battery; an electric heater; a battery charger configured to charge the battery; and a compressor including an electric motor. The wire harness is connected: to the plurality of switching devices at a first end of the wire harness; to the electric heater via the first electrical connector; to the battery charger via the second electrical connector; and to the compressor via the third electrical connector.

In a feature, a wire harness of a vehicle includes a trunk including a plurality of wires that are bundled together. A first branch branches from the trunk at a location and includes a first subset of the plurality of wires. A first electrical connector is electrically connected to the wires of the first subset of the plurality of wires, respectively. A second branch branches from the trunk at the location and includes a second subset of the plurality of wires. The wires of the second subset of the plurality of wires are different than the wires of the first subset of the plurality of wires. A second electrical connector is electrically connected to the wires of the second subset of the plurality of wires, respectively. A visual indicator is located directly on a predetermined one of the first and second branches.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system;

FIG. 2 is an example view of a vehicle including an example of a wire harness connected to various vehicle components;

FIG. 3 is an example view of a wire harness; and

FIG. 4 is an example view of a visual indicator.

In the drawings, reference numbers may be reused to identify similar and/or identical elements.

### DETAILED DESCRIPTION

A wire harness of a vehicle includes a first end including a first one or more connectors, a second end including a second one or more connectors, and a plurality of wires. The first one or more connectors connect to a first one or more components. The second one or more connectors connect to a second one or more components. The wires are connected between the first one or more connectors and the second one or more connectors.

Each of the wires includes an electrical conductor and an electrical insulator. The electrical insulator of a wire electrically isolates the electrical conductor of the wire. Each end of each wire is connected to one connector or to a specific point (e.g., pin) of one connector.

Between the first and second ends, all of the plurality of wires are bundled together (e.g., via wire wrap or wire loom), forming a trunk of the wire harness. Primary branches of one or more wires branch away from the trunk at one or more locations. Secondary branches of one or more wires branch away from primary branches at one or more locations. Tertiary branches of one or more wires branch away from secondary branches at one or more locations, and etc.

Properly installing the individual branches of a wire harness of a vehicle to the proper components during vehicle assembly is challenging. A wire harness installer has only a short period to install all of the individual branches to the proper components. A wire harness having multiple branches and connectors that are similar or identical in appearance (e.g., coloring, shape, length, etc.) may make wire harness installation even more challenging.

If the wire harness installer improperly connects one or more of the individual branches, the wire harness installer can either completely re-install the wire harness or identify the one or more improper connections and re-connect the wire harness properly. Re-installation or re-connection, however, slows the vehicle assembly process. Slowing of the vehicle assembly process may increase assembly costs of a vehicle manufacturer and decrease throughput.

According to the present disclosure, a visible indicator (e.g., a label) is included on one predetermined branch of a set of branches of a wire harness to help guide a wire harness installer to properly install the wire harness without re-installation or re-connection. For example, the visible indicator may be included on one predetermined branch of a set of branches having similar lengths, the same coloring, and the same type of connector that are to be connected to a group of components. The one predetermined branch may be, for example, for connection to one component of the group of components that is in a middle location relative to the other components of the group of components.

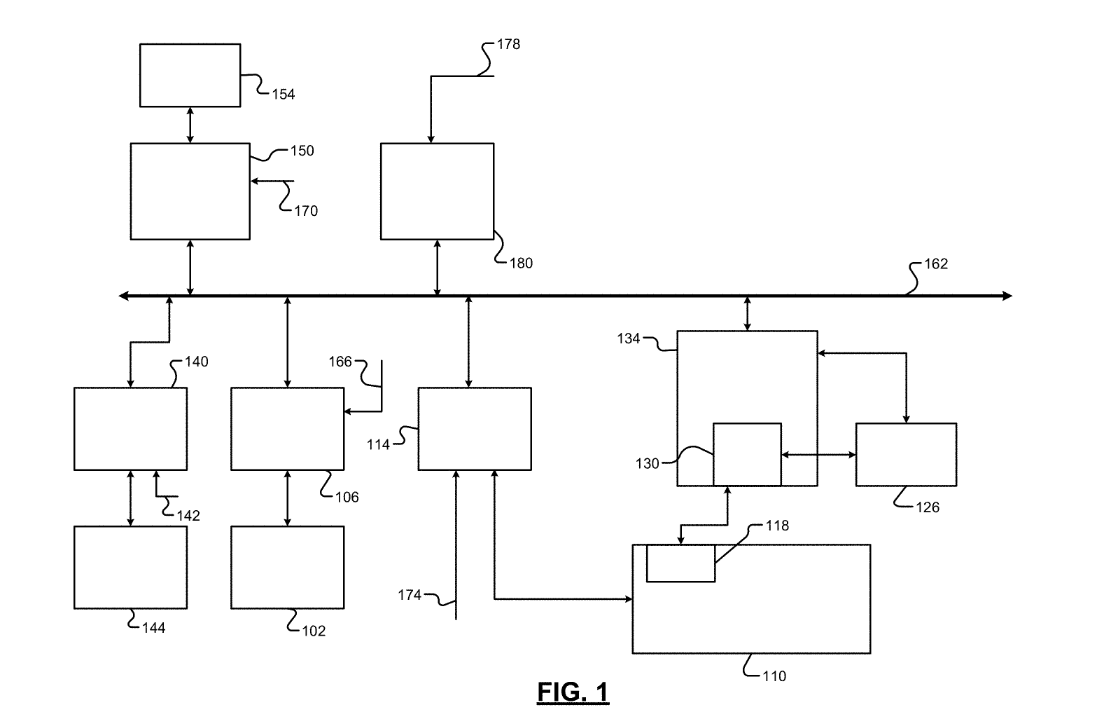

Referring now to FIG. 1, a functional block diagram of an example vehicle system is presented. While a vehicle system for a hybrid vehicle is shown and will be described, the present disclosure is also applicable to non-hybrid vehicles, electric vehicles, fuel cell vehicles, autonomous vehicles, and other types of vehicles. Also, while the example of a wire harness of a vehicle is provided, the present application is also applicable to wire harnesses of other devices.

An engine 102 combusts an air/fuel mixture to generate drive torque. An engine control module (ECM) 106 controls the engine 102. For example, the ECM 106 may control actuation of engine actuators, such as a throttle valve, one or more spark plugs, one or more fuel injectors, valve actuators, camshaft phasers, an exhaust gas recirculation (EGR) valve, one or more boost devices, and other suitable engine actuators.

The engine 102 may output torque to a transmission 110. A transmission control module (TCM) 114 controls operation of the transmission 110. For example, the TCM 114 may control gear selection within the transmission 110 and one or more torque transfer devices (e.g., a torque converter, one or more clutches, etc.).

The vehicle system may include one or more electric motors. For example, an electric motor 118 may be implemented within the transmission 110 as shown in the example of FIG. 1. An electric motor can act as either a generator or as a motor at a given time. When acting as a generator, an electric motor converts mechanical energy into electrical energy. The electrical energy can be, for example, used to charge a battery 126 via a power control device (PCD) 130. When acting as a motor, an electric motor generates torque that may be used, for example, to supplement or replace torque output by the engine 102. While the example of one electric motor is provided, the vehicle may include zero or more than one electric motor.

A power inverter control module (PIM) 134 may control the electric motor 118 and the PCD 130. The PCD 130 applies (e.g., direct current) power from the battery 126 to the (e.g., alternating current) electric motor 118 based on signals from the PIM 134, and the PCD 130 provides power output by the electric motor 118, for example, to the battery 126. The PIM 134 may be referred to as a power inverter module in various implementations.

A steering control module 140 controls steering/turning of wheels of the vehicle, for example, based on driver turning of a steering wheel within the vehicle and/or steering commands from one or more vehicle control modules. A steering wheel angle sensor monitors rotational position of the steering wheel and generates a steering wheel angle (SWA) 142 based on the position of the steering wheel. As an example, the steering control module 140 may control vehicle steering via an EPS motor 144 based on the SWA 142. However, the vehicle may include another type of steering system.

An electronic brake control module (EBCM) 150 may selectively control mechanical brakes 154 of the vehicle. Modules of the vehicle may share parameters via a network 162, such as a controller area network (CAN). In vehicles, a CAN may also be referred to as a car area network. The network 162 may include one or more data buses. Various parameters may be made available by a given control module to other control modules via the network 162.

The driver inputs may include, for example, an accelerator pedal position (APP) 166 which may be provided to the ECM 106. A brake pedal position (BPP) 170 may be provided to the EBCM 150. A position 174 of a park, reverse, neutral, drive, low (PRNDL) or another suitable range selector may be provided to the TCM 114. An ignition state 178 may be provided to a body control module (BCM) 180. For example, the ignition state 178 may be input by a driver via an ignition key, button, or switch. At a given time, the ignition state 178 may be one of off, accessory, run, and crank.

The vehicle may include one or more additional control modules that are not shown, such as a chassis control module, a battery pack control module, etc. The vehicle may omit one or more of the control modules shown and discussed.

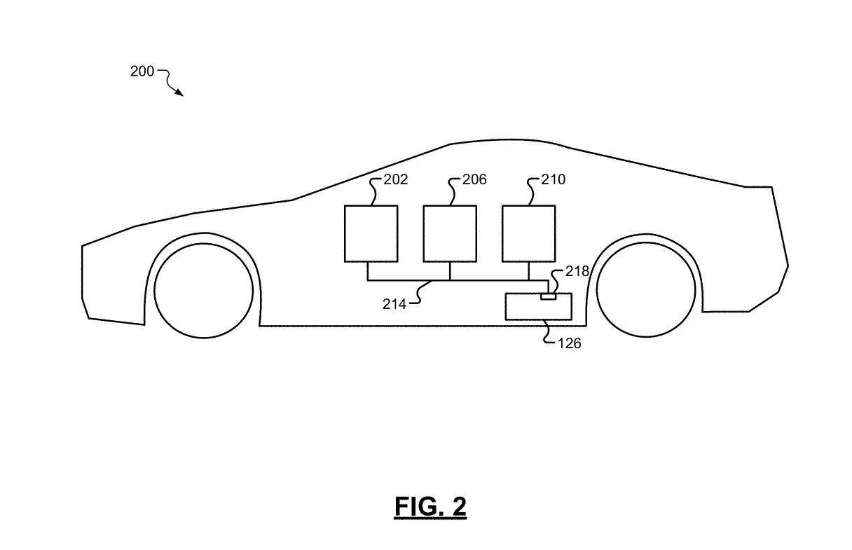

Referring now to FIG. 2, an example view of a vehicle 200 including an example wire harness 214 connected to various vehicle components is presented. In various implementations, the wire harness 214 may be part (e.g., branches) of a larger wire harness.

The wire harness 214 transmits signals and electrical power between vehicle components. For example, a battery charger 202, an electric (e.g., resistive) heater 206, and a compressor 210 (e.g., an air conditioning compressor) may be connected to switching devices (e.g., relays) 218 using the wire harness 214. The switching devices 218 may be implemented with the battery 126, such as within a battery housing. While the wire harness 214 will be discussed in conjunction with the examples of the battery charger 202, the electric heater 206, and the compressor 210, the present application is also applicable to wire harnesses connected between other components of vehicles.

The switching devices 218 connect and disconnect the battery 126 to and from the battery charger 202, the electric heater 206, and the compressor 210. For example, a first one of the switching devices 218 may connect and disconnect the battery 126 to and from the battery charger 202, a second one of the switching devices 218 may connect and disconnect the battery 126 to and from the electric heater 206, and a third one of the switching devices 218 may connect and disconnect the battery 126 to and from the compressor 210. In various implementations, the battery charger 202, the electric heater 206, and the compressor 210 may operate at voltages between 100 and 400 Volts.

Connectors for connecting to the battery charger 202, the electric heater 206, and the compressor 210 may be located in close proximity to one another. An example is as discussed further below. As an example, a second connector that is connected to the electric heater 206 may be located between first and third connectors for connecting to the battery charger 202 and the compressor 210, respectively.

The battery charger 202 may charge the battery 126 via wires of the wire harness 214. The battery charger 202 may charge the battery 126 via power received from a utility (e.g., by a cord connected between the vehicle and a wall outlet of a building). In various implementations, the battery charger 202 may be a component of the PIM 134, and the switching devices 218 may be components of the power control device 130.

The electric heater 206 is configured to heat for a passenger cabin of the vehicle 200 when power is applied to the electric heater 206. The electric heater 206 may also configured to heat the battery 126 when power is applied to the electric heater 206. The compressor 210 compresses refrigerant for cooling of the passenger cabin when power is applied to the compressor 210. The compressor 210 may also compress refrigerant for cooling of the battery 126 when power is applied to the compressor 210.

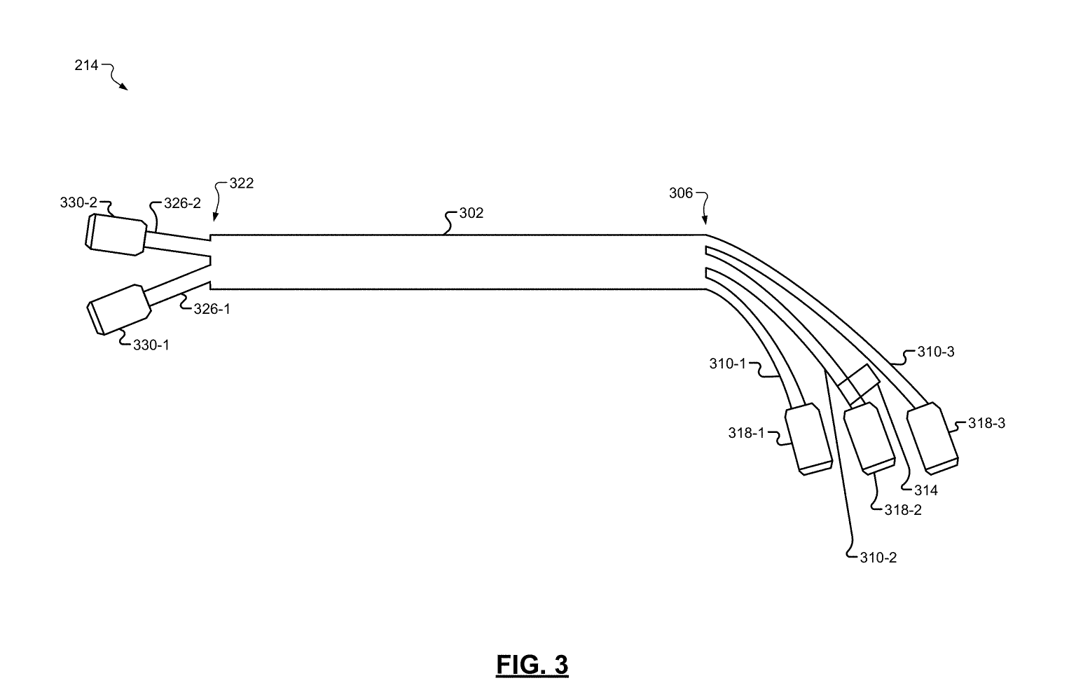

Referring now to FIG. 3, an example view of the wire harness 214 is presented. The wire harness 214 includes a trunk 302, a first end 306, and a second end 322. The trunk 302 includes a plurality of wires bundled together, such as via wire wrap or wire loom. In example of FIG. 3, at the first end 306, the plurality of wires branch into a first branch 310-1, a second branch 310-2, and a third branch 310-3.

The first branch 310-1 includes a subset of the plurality of wires, the second branch 310-2 includes a subset of the plurality of wires, and the third branch 310-3 includes a subset of the plurality of wires. While the example of the trunk 302 branching into three branches at the first end 306 is provided, the trunk 302 may branch into more than three branches at the first end 306. Also, one or more branches may further branch into two or more sub-branches, and so on. The present application is applicable to wire harnesses including flexible branches, wire harnesses including rigid branches, and wire harnesses including a combination of rigid and flexible branches.

The first branch 310-1, the second branch 310-2, and the third branch 310-3 may collectively be referred to as vehicle component branches 310. A connector is attached to the wires of each of the vehicle component branches 310. For example, a first connector 318-1 is connected to the first branch 310-1, a second connector 318-2 is connected to the second branch 310-2, and a third connector 318-3 is connected to the third branch 310-3. The first connector 318-1, the second connector 318-2, and the third connector 318-3 may collectively be referred to as vehicle component connectors 318. The first connector 318-1 may be configured to connect to a first connector that is electrically connected to the battery charger 202, the second connector 318-2 may be configured to connect to a second connector that is electrically connected to the electric heater 206, and the third connector 318-3 may be configured to connect to a third connector that is electrically connected to the compressor 210.

In example of FIG. 3, at the second end 322, the trunk 302 branches into a fourth branch 326-1 and a fifth branch 326-2. The fourth branch 326-1 includes a subset of the plurality of wires and the fifth branch 326-2 includes a subset of the plurality of wires. While the example of the trunk 302 branching into two branches at the second end 322 is provided, one or more connectors may be connected to the plurality of wires at the second end 322, or the trunk 302 may branch into more than two branches at the second end 322. Also, one or more branches may further branch into two or more sub-branches, and etc. In various implementations, the trunk 302 may be part of a larger trunk of wires.

The fourth branch 326-1 and the fifth branch 326-2 are collectively referred to as switching device branches 326. A connector is attached to the wires of each of the switching device branches 326. For example, a fourth connector 330-1 is connected to the fourth branch 326-1, and a fifth connector 330-2 is connected to the fifth branch 326-2. The fourth connector 330-1 and the fifth connector 330-2 may collectively be referred to as switching device connectors 330. The fourth connector 330-1 may be configured to connect to a first connector that is electrically connected to a first one or more of the switching devices 218, and the fifth connector 330-2 may be configured to connect to a second one or more of the switching devices 218.

The trunk 302 is the main portion of the wire harness 214 where the plurality of wires are bundled together, for example, via wire wrap or wire loom. The bundling of the wires may, for example, secure the plurality of wires for vibration, abrasion, moisture, and/or one or more other reasons. As discussed above, each wire of the plurality of wires may include an electrical insulator to electrically insulate its electrical conductor from other electrical conductors. The vehicle component connectors 318 and the switching device connectors 330 may be either male type connectors, female type connectors, or a mixture of male type and female type connectors.

A wire harness installer has only a short period to install all of the individual branches to the proper components. A wire harness having multiple branches and connectors that are similar or identical in appearance (e.g., coloring, shape, length, etc.) may make wire harness installation even more challenging.

If the wire harness installer improperly connects one or more of the individual branches, the wire harness installer can either completely re-install the wire harness or identify the one or more improper connections and re-connect the wire harness properly. Re-installation or re-connection, however, slows the vehicle assembly process. Slowing of the vehicle assembly process may increase assembly costs of a vehicle manufacturer and decrease throughput.

For example, if the vehicle component branches 310 have wires of the same color (e.g., only one color), similar lengths (e.g., within a predetermined length of each other), and have the same type of connector attached, the wire harness installer may accidentally confuse one of the vehicle component branches 310 with another one of the vehicle component branches. An example predetermined length may be, for example, ¼″, ½″, ¾″, or another length where an accuracy of visual differentiation based on length is less than a predetermined accuracy. This may cause the wire harness installer to improperly connect the vehicle component connectors 318 with improper ones of the connectors that are connected to the battery charger 202, the electric heater 206, and the compressor 210, respectively.

Including a visual indicator on one predetermined branch of a group of two or more branches that appear similar to each other (e.g., have wires of the same color, similar lengths (e.g., within a predetermined length of each other), and have similar connectors) may help the wire harness installer during the installation process of the wire harness. The one predetermined branch may be, for example, the one of the branches of the group of three or more branches that is to be connected to a connector that is physically located in a middle location of a group of three or more connectors. In groups of three or more branches and connectors having an even number of branches (e.g., 2, 4, 6, 8, etc.), the middle may be the left middle or the right middle one of the branches. While the example of the middle is provided, the visual indicator may be provided on another predetermined branch of a group of three or more branches that appear similar to each other.

For example, in the example of FIG. 3, the visual indicator may be a label 314 affixed on the one predetermined branch of the vehicle component branches 310. The second branch 310-2 is the one predetermined branch in the example of FIG. 3. By the label 314 being present on the second branch 310-2, the wire harness installer may be able to determine connector to connect to the second connector 318-2 of the second branch 310-2. The wire harness installer may be able to visually differentiate between the first branch 310-1 and the third branch 310-3. For example, the first branch 310-1 may be shorter in length than the third branch 310-3. Although the label 314 is shown and discussed to denote the second branch 310-2, the label 314 may be used to denote the first branch 310-1, the third branch 310-3, or any other branches.

The label 314 may include a medium affixed using an adhesive, or the label 314 may be directly printed onto the one predetermined branch. The label 314 may be printed directly onto the one predetermined branch, for example, via ink, heat, laser, etc. The medium may include, for example, paper, plastic, film, cloth, or metal. The size of the label 314 may be, for example, 1.5 inches in length and 1.5 inches in width or have other suitable dimensions. The label 314 may include information or may simply be colored, such as a predetermined color.

Additionally or alternatively, the one predetermined branch may be longer than the other branches of the group of branches to serve as the visual indicator. In the example of FIG. 3, the third branch 310-3 may be lengthened by a predetermined amount such that the third branch 310-3 is visually distinguishable from the other branches. While the example of increasing the length of a branch is discussed, shortening of the one predetermined branch may alternatively be used as the visual indicator.

Additionally or alternatively, a different color of connector may be attached to the one predetermined branch to serve as the visual indicator. For example, in FIG. 3, the connector attached to the second branch 310-2 may be a first color (e.g., green) and the connectors attached to the first and third branches 310-1 and 310-3 may be one or more other colors that is/are different than the first color (e.g., white). The connector to which the connector of the second branch 310-2 is to be connected may also be the first color. The connector to which the connector of the first branch 310-1 is to be connected may be the same color as the connector of the first branch 310-1. The connector to which the connector of the third branch 310-3 is to be connected may be the same color as the connector of the third branch 310-3.

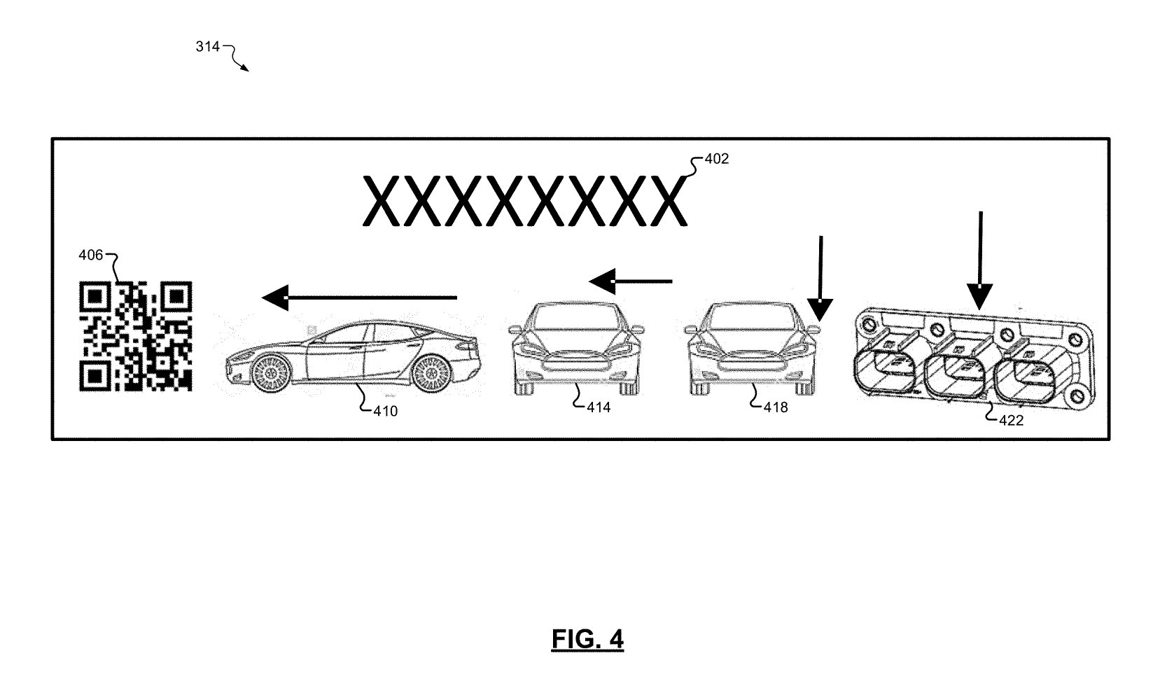

Referring now to FIG. 4, a view of an example implementation of the label 314 is presented. The label 314 may have a part number 402 of the wire harness 214. The part number 402 may include alphanumeric characters. The part number 402 may be printed in black ink and may start with the acronym P/N.

The label 314 may have one or more visual indicators to aid the wire harness installer during the installation of the wire harness 214. For example, the label 314 may include such as an optically recognizable identifier 406, a first vehicle orientation indicator 410, a second vehicle orientation indicator 414, a third vehicle orientation indicator 418, and a mating connection indicator 422. The optically recognizable identifier 406 may be, for example, a one-dimensional barcode (e.g., string of one or more letters, numbers, characters, and/or symbols, a stock keeping unit (SKU), universal product code (UPC), etc.), a two-dimensional barcode (e.g., data matrix, a quick response (QR) code, etc.), a three-dimensional barcode, or another suitable type of identifier that is optically recognizable. The optically recognizable identifier 406 corresponds to a unique identifier (e.g., serial number) of the wire harness 214.

The wire harness installer or a handheld electronic device (e.g., including a scanner) may determine a vehicle identifier (ID) associated with a vehicle to be assembled, for example, by scanning an optically recognizable identifier located on the vehicle. For example, the vehicle ID may include a vehicle identification number (VIN) or another suitable ID of the vehicle. The wire harness installer may also identify (e.g., scan) the optically recognizable identifier 406 with the handheld electronic device. The handheld electronic device may transmit the vehicle ID and the optically recognizable identifier 406 to a computer. The computer may store the vehicle ID and the optically recognizable identifier 406 together in memory so that the vehicle manufacture may later identify which wire harness was installed in the vehicle. In various implementations, the computer or the handheld electronic device may be programed to display information on how to properly orientate the wire harness 214 in the vehicle.

The first vehicle orientation indicator 410 serves as a visual indicator (e.g., to the wire harness installer) of whether the one end of the wire harness having the predetermined one of the branches with the visual indicator should be positioned more forward or rearward than the other end of the wire harness not having the predetermined one of the branches with the visual indicator. For example, the first vehicle orientation indicator 410 in FIG. 4 includes an arrow pointing toward the front (or forward direction) of the vehicle. Using the example of the wire harness 214 of FIG. 3, the first vehicle orientation indicator 410 may serve as a visual indicator that the first end 306 (having the one predetermined branch with the visual indicator) of the wire harness 214 is to be connected more toward the front of the vehicle than the second end 322 of the wire harness 214 (not having the one predetermined branch with the visual indicator). Although the first vehicle orientation indicator 410 is shown and discussed as forward facing, the first vehicle orientation indicator 410 may indicate backward/reverse in implementations where the one end of the wire harness having the predetermined one of the branches with the visual indicator should be positioned more rearward than the other end of the wire harness not having the predetermined one of the branches with the visual indicator.

The second vehicle orientation indicator 414 serves as a visual indicator (e.g., to the wire harness installer) of whether the one end of the wire harness having the predetermined one of the branches with the visual indicator should be positioned more leftward or rightward than the other end of the wire harness not having the predetermined one of the branches with the visual indicator. For example, the second vehicle orientation indicator 414 in FIG. 4 includes an arrow pointing toward the left side of the vehicle. Using the example of the wire harness 214 of FIG. 3, the second vehicle orientation indicator 414 may serve as a visual indicator that the first end 306 (having the one predetermined branch with the visual indicator) of the wire harness 214 is to be connected more toward the left side of the vehicle than the second end 322 of the wire harness 214 (not having the one predetermined branch with the visual indicator). Although the second vehicle orientation indicator 414 is shown and discussed as leftward facing, the second vehicle orientation indicator 414 may indicate rightward in implementations where the one end of the wire harness having the predetermined one of the branches with the visual indicator should be positioned more toward the right of the vehicle than the other end of the wire harness not having the predetermined one of the branches with the visual indicator.

The third vehicle orientation indicator 418 serves as a visual indicator (e.g., to the wire harness installer) of whether the one end of the wire harness having the predetermined one of the branches with the visual indicator should be positioned more upward or downward than the other end of the wire harness not having the predetermined one of the branches with the visual indicator. For example, the third vehicle orientation indicator 418 in FIG. 4 includes an arrow pointing toward the bottom of the vehicle. Using the example of the wire harness 214 of FIG. 3, the third vehicle orientation indicator 418 may serve as a visual indicator that the first end 306 (having the one predetermined branch with the visual indicator) of the wire harness 214 is to be connected more toward the bottom of the vehicle than the second end 322 of the wire harness 214 (not having the one predetermined branch with the visual indicator). Although the third vehicle orientation 418 indicator is discussed as more downward facing, the third vehicle orientation 418 indicator may indicate upward in implementations where the one end of the wire harness having the predetermined one of the branches with the visual indicator should be positioned more toward the top of the vehicle than the other end of the wire harness not having the predetermined one of the branches with the visual indicator.

The mating connection indicator 422 serves as a visual indicator (e.g., to the wire harness installer) of how to connect the connectors of the group of branches (the predetermined one branch having the visual indicator) to the respective connectors that are connected to vehicle components. Specifically, the mating connection indicator 422 indicates which one of the connectors the predetermined one branch having the visual indicator should be connected to. For example, the mating connection indicator 422 in FIG. 4 includes an arrow pointing toward the middle connector of a group of three connectors of the vehicle. Using the example of the wire harness 214 of FIG. 3 having the label 314 on the second branch 310-2, the mating connection indicator 422 may serve as a visual indicator that the connector of the second branch 310-2 should be connected to the middle connector of the group of three connectors of the vehicle.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A wire harness of a vehicle, comprising:
a trunk including a plurality of wires that are bundled together;
a first branch that branches from the trunk at a location and that includes a first subset of the plurality of wires;
a first electrical connector that is electrically connected to the wires of the first subset of the plurality of wires, respectively;
a second branch that branches from the trunk at the location and that includes a second subset of the plurality of wires,
wherein the wires of the second subset of the plurality of wires are different than the wires of the first subset of the plurality of wires;
a second electrical connector that is electrically connected to the wires of the second subset of the plurality of wires, respectively;
a third branch that branches from the trunk at the location, that includes a third subset of the plurality of wires,
wherein the wires of the third subset of the plurality of wires are different than:
the wires of the first subset of the plurality of wires; and
the wires of the second subset of the plurality of wires;
a third electrical connector that is electrically connected to the wires of the third subset of the plurality of wires, respectively; and
a visual indicator located directly on a predetermined one of the first, second, and third branches.

2. The wire harness of claim 1 wherein:
the first branch has a first length;
the second branch has a second length that is greater than the first length;
the third branch has a third length that is greater than the second length; and
the visual indicator is located directly on the second branch.

3. The wire harness of claim 2 wherein:
a first difference between the first length and the second length is less than a predetermined length; and
a second difference between the second length and the third length is less than the predetermined length.

4. The wire harness of claim 1 wherein:
one of the plurality of wires includes an electrical insulator that is the same color as electrical insulators of all of the other ones of the plurality of wires;
a first difference between a first length of the first branch and a second length of the second branch is less than a predetermined length;
a second difference between the second length of the second branch and a third length of the third branch is less than the predetermined length; and
the first electrical connector is the same color as the second and third electrical connectors.

5. The wire harness of claim 1 wherein the visual indicator includes one of the first, second, and third electrical connectors connected to the predetermined one of the first, second, and third branches being a different color than the other ones of the first, second, and third electrical connectors.

6. The wire harness of claim 1 wherein the visual indicator includes one of the first, second, and third subsets of the plurality of wires being a different color than the other ones of the first, second, and third subsets of the plurality of wires.

7. The wire harness of claim 1 wherein the visual indicator is a label that is directly on the predetermined one of the first, second, and third branches.

8. The wire harness of claim 7 wherein the label is printed directly on the predetermined one of the first, second, and third branches.

9. The wire harness of claim 7 wherein the label is affixed directly to the predetermined one of the first, second, and third branches.

10. The wire harness of claim 7 wherein the label includes a part number of the wire harness.

11. The wire harness of claim 7 wherein the label includes a unique identifier of the wire harness.

12. The wire harness of claim 7 wherein the label includes a visual indicator of which one of a plurality of mating connectors that is to be mated with the one of the first, second, and third electrical connectors that is connected to the predetermined one the first, second, and third branches.

13. The wire harness of claim 7 wherein the label includes a visual indicator of whether the first, second, and third branches should be installed more toward one of:
a front of the vehicle; and
a rear of the vehicle.

14. The wire harness of claim 7 wherein the label includes a visual indicator of whether the first, second, and third branches should be installed more toward one of:
a left side of the vehicle; and
a right side of the vehicle.

15. The wire harness of claim 7 wherein the label includes a visual indicator of whether the first, second, and third branches should be installed more toward one of:
a top of the vehicle; and
a bottom of the vehicle.

16. The wire harness of claim 7 wherein the label:
is affixed directly to the predetermined one of the first, second, and third branches;
includes a part number of the wire harness;
includes a unique identifier of the wire harness;
includes a first visual indicator of which one of a plurality of mating connectors that is to be mated with the one of the first, second, and third electrical connectors that is connected to the predetermined one the first, second, and third branches;
includes a second visual indicator of whether the first, second, and third branches should be installed more toward one of:
a front of the vehicle; and
a rear of the vehicle;
includes a third visual indicator of whether the first, second, and third branches should be installed more toward one of:
a left side of the vehicle; and
a right side of the vehicle; and
includes a fourth visual indicator of whether the first, second, and third branches should be installed more toward one of:
a top of the vehicle; and
a bottom of the vehicle.

17. A vehicle including:
a battery;
a plurality of switching devices that are electrically connected to the battery;
an electric heater;
a battery charger configured to charge the battery; and
a compressor including an electric motor; and
the wire harness of claim 1, wherein the wire harness is connected:
to the plurality of switching devices at a first end of the wire harness;
to the electric heater via the first electrical connector;
to the battery charger via the second electrical connector; and
to the compressor via the third electrical connector.

18. A wire harness of a vehicle, comprising:
a trunk including a plurality of wires that are bundled together;
a first branch that branches from the trunk at a location and that includes a first subset of the plurality of wires;
a first electrical connector that is electrically connected to the wires of the first subset of the plurality of wires, respectively;
a second branch that branches from the trunk at the location and that includes a second subset of the plurality of wires,
wherein the wires of the second subset of the plurality of wires are different than the wires of the first subset of the plurality of wires;
a second electrical connector that is electrically connected to the wires of the second subset of the plurality of wires, respectively;
a third branch that branches from the trunk at the location, that includes a third subset of the plurality of wires,
wherein the wires of the third subset of the plurality of wires are different than:
the wires of the first subset of the plurality of wires; and
the wires of the second subset of the plurality of wires;
a third electrical connector that is electrically connected to the wires of the third subset of the plurality of wires, respectively; and
a label that is affixed directly to a predetermined one of the first, second, and third branches and not on the trunk and that includes:
a part number of the wire harness;
a unique identifier of the wire harness;
a first visual indicator of which one of a plurality of mating connectors that is to be mated with the one of the first, second, and third electrical connectors that is connected to the predetermined one the first, second, and third branches;
a second visual indicator of whether the first, second, and third branches should be installed more toward:
a front of the vehicle; or
a rear of the vehicle;
a third visual indicator of whether the first, second, and third branches should be installed more toward:
a left side of the vehicle; or
a right side of the vehicle;
a fourth visual indicator of whether the first, second, and third branches should be installed more toward:
a top of the vehicle; or
a bottom of the vehicle; and
wherein:
one of the plurality of wires includes an electrical insulator that is the same color as electrical insulators of all of the other ones of the plurality of wires;
a first difference between a first length of the first branch and a second length of the second branch is less than a predetermined length;
a second difference between the second length of the second branch and a third length of the third branch is less than the predetermined length; and
the first electrical connector is the same color as the second and third electrical connectors.

19. A vehicle including:
a battery;
a plurality of switching devices that are electrically connected to the battery;
an electric heater;
a battery charger configured to charge the battery; and
a compressor including an electric motor; and
the wire harness of claim 18, wherein the wire harness is connected:
to the plurality of switching devices at a first end of the wire harness;
to the electric heater via the first electrical connector;
to the battery charger via the second electrical connector; and
to the compressor via the third electrical connector.

20. A wire harness comprising:
a plurality of wires that are bundled together;
a first branch that branches from the plurality of wires at a location and that includes a first subset of the plurality of wires;
a first electrical connector that is electrically connected to the wires of the first subset of the plurality of wires, respectively;
a second branch that branches from the plurality of wires at the location and that includes a second subset of the plurality of wires,
wherein the wires of the second subset of the plurality of wires are different than the wires of the first subset of the plurality of wires;
a second electrical connector that is electrically connected to the wires of the second subset of the plurality of wires, respectively; and
a visual indicator that is located directly on a predetermined one of the first and second branches.
